(19) United States
(12) Patent Application Publication
(10) Pub. No.: US 2020/0333648 A1
(43) Pub. Date: Oct. 22, 2020

(54) DISPLAY PANEL AND MANUFACTURING METHOD FOR DISPLAY DEVICE

(71) Applicant: SHARP KABUSHIKI KAISHA, Sakai City (JP)

(72) Inventor: HIROMI ENOMOTO, Sakai City (JP)

(21) Appl. No.: 16/845,757

(22) Filed: Apr. 10, 2020

Related U.S. Application Data
(60) Provisional application No. 62/836,359, filed on Apr. 19, 2019.

(51) Int. Cl. G02F 1/133; B60R 1/12

(52) U.S. Cl. CPC G02F 1/13306; B60R 1/12; B60R 11/04; B60R 2001/1215; G02F 2203/02

(57) ABSTRACT

A display panel includes: a memory pixel section including a memory circuit configured to store display data; and a non-memory pixel section that does not have a function of storing display data, wherein a plurality of the memory pixel sections are disposed on an outer circumference side of a plurality of the non-memory pixel sections.

### CROSS-REFERENCE TO RELATED APPLICATION

The present application claims priority from Provisional Application No. 62/836,359, the content to which is hereby incorporated by reference into this application.

### BACKGROUND OF THE INVENTION

### 1. Field of the Invention

The present invention relates to a display panel, and relates to a manufacturing method for a display device configured to include the display panel.

### 2. Description of the Related Art

In recent years, display panels have been employed in, for example, in-vehicle mirror displays (mirror monitors) described in Japanese Unexamined Patent Application Publication No. 2018-103866, wearable terminals, or the like. These mirror displays, wearable terminals and the like are excellent in designability, and among the display panels employed in these mirror displays and wearable terminals, a display panel with a special shape, a frame narrowing display panel and the like may be employed in accordance with frames of various types of designing. On the other hand, the display panel (liquid crystal panel) is generally square-shaped and a black matrix is disposed around a display region to form a frame region, as described in Japanese Patent No. 5893449. Incidentally, Japanese Unexamined Patent Application Publication No. 2018-103866 describes that each of a plurality of subpixels constituting one pixel is constituted by a pixel having memory properties so that a fluctuation in potential of a pixel electrode is suppressed and a display state can be maintained even when the potential of the pixel electrode fluctuates.

### SUMMARY OF INVENTION

In the mirror displays described in the above Japanese Unexamined Patent Application Publication No. 2018-103866, wearable terminals, and the like, various frame shapes exist as described above even when they have approximately the same size. As a result, because the frame shapes are slightly different, it may be necessary to design a display panel for each of the frames. In addition, even if the same display panel is employed for the different frames, there may be a case in which a non-display region exists between a display region and the frame of the display panel so that the designability of the terminal is degraded due to the existence of the non-display region.

An aspect of the present invention has been conceived in view of such circumstances, and an object of the present invention is to provide a display panel able to be employed for frames of various designs and to achieve a display device excellent in designability.

(1) An embodiment of the present invention is a display panel that includes a memory pixel section having a memory circuit configured to store display data, and a non-memory pixel section that does not have a function of storing display data, wherein a plurality of the memory pixel sections are disposed on an outer circumference side of a plurality of the non-memory pixel sections.

(2) Further, a certain embodiment of the present invention is a display panel in which, in addition to the configuration of (1) described above, the plurality of memory pixel sections are disposed to surround an entire circumference of a non-memory pixel region formed by the plurality of non-memory pixel sections.

(3) Further, a certain embodiment of the present invention is a display panel in which, in addition to the configuration of (1) or (2) described above, color display is able to be performed in a memory pixel region formed by the plurality of memory pixel sections.

(4) Further, a certain embodiment of the present invention is a display panel configured to be able to switch between a display state to display an image and a mirror state to function as a mirror, in addition to the configuration of any one of (1) to (3) described above.

(5) Furthermore, a certain embodiment of the present invention is a display panel that includes, in addition to the configuration of any one of (1) to (4) described above, a drive circuit designed to supply scanning signals to the plurality of memory pixel sections and to the plurality of non-memory pixel sections, and scanning wiring lines configured to supply the scanning signals to the memory pixel sections and to the non-memory pixel sections, wherein the drive circuit is disposed overlapping the memory pixel region formed by the plurality of memory pixel sections and the non-memory pixel region formed by the plurality of non-memory pixel sections, and the scanning wiring lines are disposed to extend toward both sides from the drive circuit.

(6) In addition, another embodiment of the present invention is a manufacturing method for a display device configured to include the display panel with the configuration of (5) and a frame member that is formed in a frame shape and holds the display panel, and the method includes a cutting process in which part of the memory pixel region of the display panel is cut out to form a shape fitted for the frame member.

According to an aspect of the present invention, it is possible to provide a display panel able to be employed for frames of various designs, and to achieve a display device excellent in designability.

### BRIEF DESCRIPTION OF DRAWINGS

FIG. 1 is a diagram illustrating a room mirror monitor for a vehicle configured to include a liquid crystal panel of a first example of the present invention.

FIG. 2 is a front view illustrating a state in which an image is displayed in the liquid crystal panel illustrated in FIG. 1.

FIG. 3 is a circuit diagram schematically illustrating a configuration of the liquid crystal panel in a non-memory pixel region illustrated in FIG. 2.

FIG. 4 is a circuit diagram schematically illustrating a configuration of the liquid crystal panel in a memory pixel region illustrated in FIG. 2.

FIG. 5 is a diagram illustrating a state of the liquid crystal panel illustrated in FIG. 1 before being cut.

FIG. 6A is a diagram illustrating a liquid crystal panel formed from the liquid crystal panel illustrated in FIG. 5 so as to be fitted for another frame.

FIG. 6B is a diagram illustrating a liquid crystal panel formed from the liquid crystal panel illustrated in FIG. 5 so as to be fitted for still another frame.

FIG. 7A is a diagram illustrating a state of gradation display performed on a memory pixel region of the liquid crystal panel illustrated in FIG. 1.

FIG. 7B is a diagram illustrating a state of gradation display performed on a memory pixel region of the liquid crystal panel illustrated in FIG. 6B.

FIG. 8 is a circuit diagram schematically illustrating a configuration in a memory pixel region of a liquid crystal panel of a second example.

FIG. 9A is a diagram illustrating a state of color display performed on a memory pixel region of the liquid crystal panel illustrated in FIG. 6A.

FIG. 9B is a diagram illustrating a state of color display performed on a memory pixel region of the liquid crystal panel illustrated in FIG. 6B.

### DETAILED DESCRIPTION OF THE INVENTION

Hereinafter, as an embodiment to implement the present invention, several examples of the present invention will be described in detail with reference to the drawings. Note that the present invention is not limited to the examples described below, and the present invention may be implemented by various aspects in which various alterations and improvements are made in light of the knowledge of those skilled in the art.

### Example 1

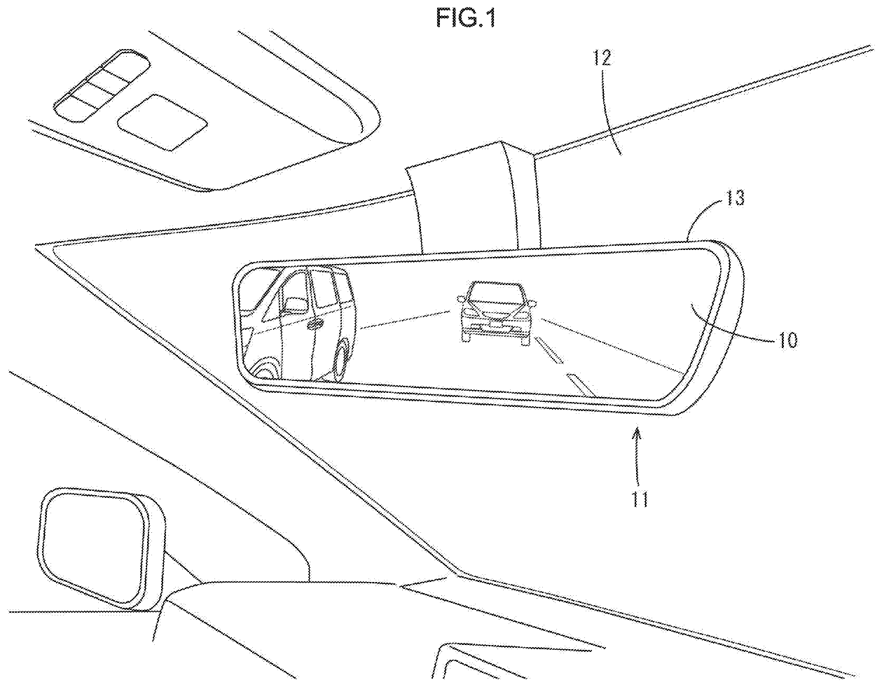

A display panel of a first example of the present invention is a liquid crystal panel 10, and is employed in a room mirror monitor 11 as a display device mounted in a vehicle, as illustrated in FIG. 1. The room mirror monitor 11 is provided on the upper side of the center in a vehicle width direction at a front window 12 of the vehicle, and typically functions as a room mirror (center mirror) for the driver of the vehicle to visually recognize the rear of the vehicle. Specifically, the liquid crystal panel 10 of the present example employed in the room mirror monitor 11 is referred to as a so-called mirror display, and is configured to be able to switch between a display state to display an image and a mirror state to function as a mirror. The liquid crystal panel 10 may have a configuration in which a pixel includes a reflective layer or a configuration in which a half mirror material is used, for example.

Accordingly, the room mirror monitor 11 is brought into the mirror state to function as a mirror when the liquid crystal panel 10 is not activated, and brought into the state to display various images by activating the liquid crystal panel 10. Note that the room mirror monitor 11 makes it possible to display, on the liquid crystal panel 10, for example, an image as an alternative to a center mirror by a rear camera provided facing to the rear at the rear side of the vehicle, an image as a rear monitor during the vehicle being parked, an image of a car navigation system, images of TV and DVD, information, and the like, on the vehicle. Incidentally, the room mirror monitor 11 is provided with a backlight device, and is configured to radiate light to the liquid crystal panel 10 from the back face side thereof with the backlight device.

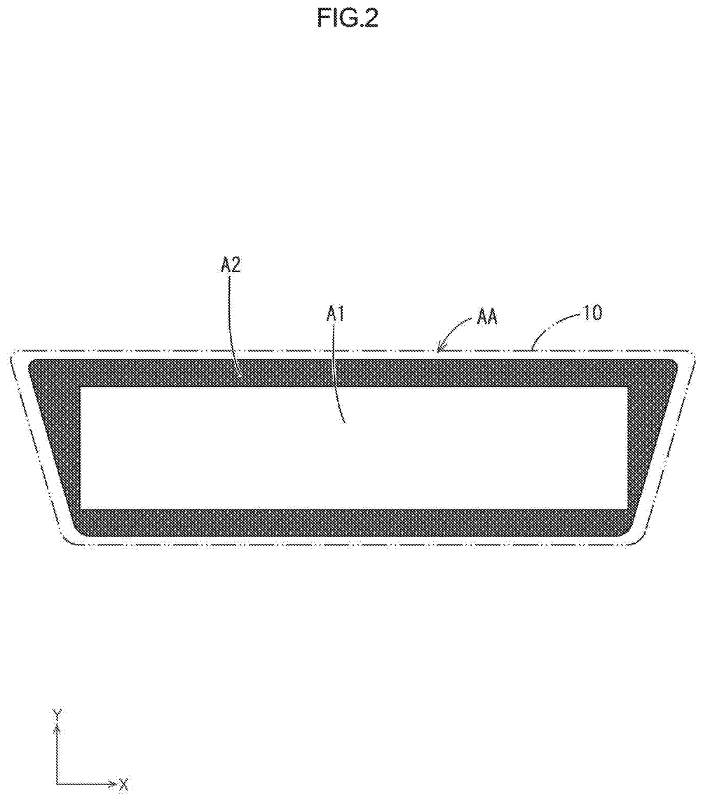

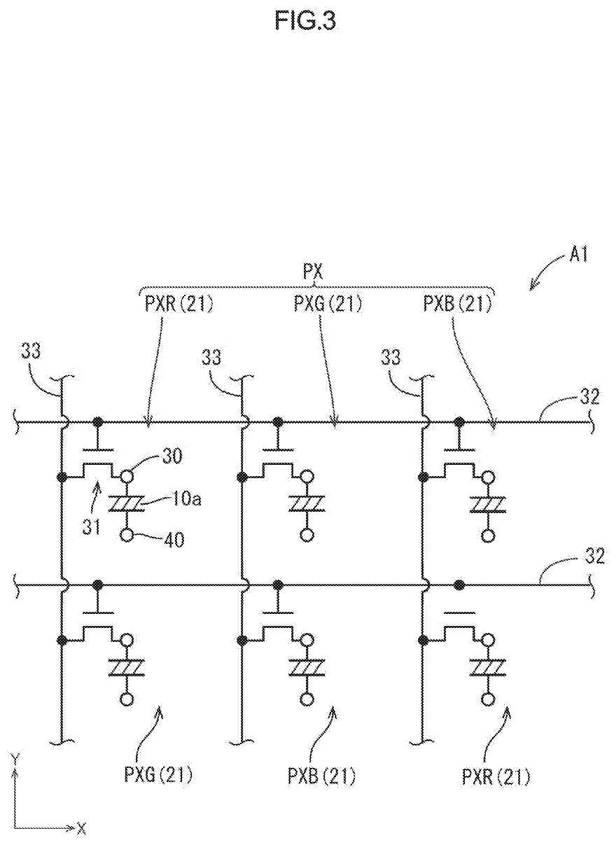

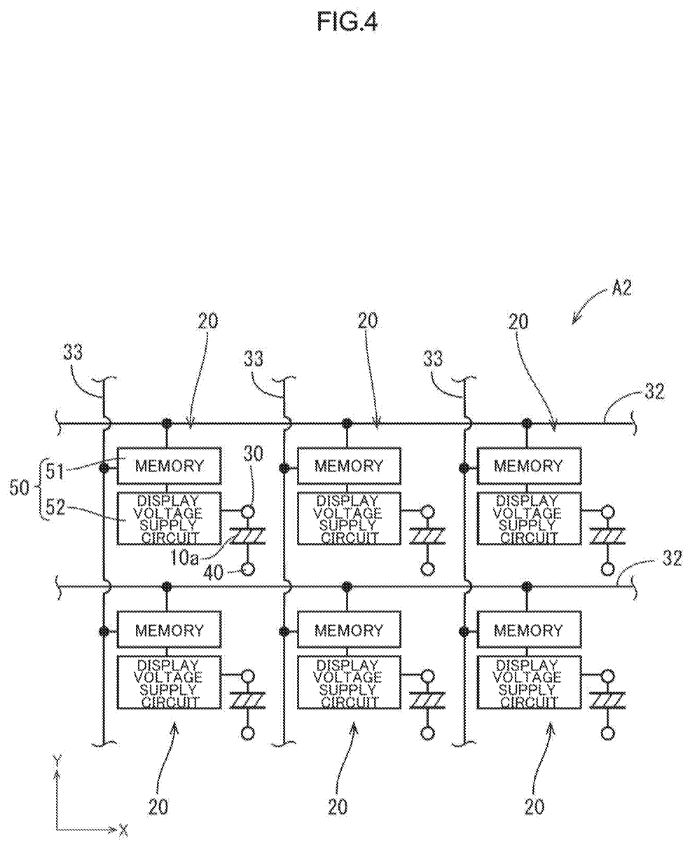

A substantially entire surface of the liquid crystal panel 10 in the room mirror monitor 11 is a displayable region, and a portion of the room mirror monitor 11 that is not covered by a frame member 13 (actual display region AA) is illustrated in FIG. 2 with a solid line. Note that a double-dot dash line in FIG. 2 indicates an external shape of the liquid crystal panel 10. As illustrated in FIG. 2, the external shape and the actual display region AA are both formed in inverted trapezoidal shapes. The liquid crystal panel 10 includes a pair of substrates and a liquid crystal layer 10a (see FIG. 3 and FIG. 4) sandwiched between the pair of substrates and containing therein liquid crystal molecules, which are substances whose optical characteristics change with the application of an electric field. Of the pair of substrates, a substrate disposed on the front side (outer side of the room mirror monitor 11) is a counter substrate (CF substrate), and a substrate disposed on the rear side (inner side of the room mirror monitor 11) is an array substrate. Then, in the display region, a plurality of pixel units to display an image are disposed in a matrix shape.

The liquid crystal panel 10 is configured to include a memory pixel section 20, in which a plurality of pixel units have a function of storing display data, and a non-memory pixel section 21, in which none of a plurality of pixel units have a function of storing display data. In detail, as illustrated in FIG. 2, the central portion of the display surface is a non-memory pixel region A1, in which a plurality of non-memory pixel sections 21 are disposed, and a portion on the outer circumference side of the non-memory pixel region A1 is a memory pixel region A2, in which a plurality of memory pixel sections 20 are disposed. Note that the memory pixel region A2 is formed to surround the entire circumference of the non-memory pixel region A1.

The non-memory pixel section 21 is configured to include a pixel electrode 30 provided on the array substrate side, and color filters that are provided in the counter substrate and exhibit red, green, and blue colors. The configuration of the non-memory pixel section 21 will be described in detail below. First, as illustrated in FIG. 3, the pixel electrode 30 and a thin film transistor (TFT) 31, which is a switching element and is provided corresponding to the pixel electrode 30, are arranged in a matrix shape (determinant form) in the array substrate. In addition, a scanning wiring line (gate wiring line) 32 extending in a row direction (X-axis direction) and a data wiring line (source wiring line) 33 extending in a column direction (Y-axis direction) are disposed in the array substrate to form a lattice pattern, and the pixel electrode 30 and the TFT 31 are in a state surrounded by the scanning wiring lines 32 and the data wiring lines 33. Then, the scanning wiring line 32 and the data wiring line 33 are connected to the gate electrode and the source electrode, respectively, of the TFT 31, and the pixel electrode 30 is connected to the drain electrode of the TFT 31. Note that the TFT 31 is driven based on various signals supplied to the scanning wiring line 32 and the data wiring line 33 respectively, and with the drive thereof, the supply of a potential to the pixel electrode 30 is controlled. Incidentally, the pixel electrode 30 is disposed in a rectangular region surrounded by the scanning wiring lines 32 and the data wiring lines 33, and is formed of a transparent electrode such as indium tin oxide (ITO) or zinc oxide (ZnO).

On the other hand, in the counter substrate, multiple color filters are provided being arranged in a matrix shape at positions facing each of the pixel electrodes 30 on the array substrate side. As for the color filters, filters configured to exhibit three colors of red, green, and blue (R, G, B) are repeatedly disposed being arranged in a predetermined order. The color filter of each color is so configured as to selectively transmit light in a specific wavelength range in accordance with each of the colors. That is, the red color filter selectively transmits light in the red wavelength region, the green color filter selectively transmits light in the green wavelength region, and the blue color filter selectively transmits light in the blue wavelength region. A counter electrode 40 in solid-like form (see FIGS. 3 and 4) opposing the pixel electrode 30 on the array substrate side is provided on a surface of the color filter.

Then, in the non-memory pixel region A1, one display pixel PX, which is a display unit, is constituted by a set of three color filters of red, green and blue, and three pixel electrodes 30 facing the three color filters. That is, the display pixel PX is constituted of three non-memory pixel sections 21. To be specific, the display pixel PX includes a red pixel section PXR constituted of a color filter configured to exhibit red color and the pixel electrode 30 facing the red color filter, a green pixel section PXG constituted of a color filter configured to exhibit green color and the pixel electrode 30 facing the green color filter, and a blue pixel section PXB constituted of a color filter configured to exhibit blue color and the pixel electrode 30 facing the blue color filter. The pixel sections PXR, PXG, and PXB of respective colors are repeatedly disposed side-by-side along the row direction (X-axis direction) on a plate face of the liquid crystal panel 10 to form a group of pixels, and the multiple groups of pixels are disposed side-by-side along the column direction (Y-axis direction).

Further, the memory pixel section 20 takes a memory in pixel (MIP) scheme, and is configured to include the pixel electrode 30 provided on the array substrate side and a memory circuit 50, as illustrated in FIG. 4. The memory circuit 50 includes a memory (SRAM) 51 configured to store display data sent from the data wiring line 33, and a display voltage supply circuit 52 configured to supply a voltage corresponding to the display data stored in the memory 51 to the pixel electrode 30. Then, as illustrated in FIG. 4, the pixel electrode 30 and the memory circuit 50 provided corresponding to the pixel electrode 30 are disposed being arranged in a matrix shape (determinant form) in the array substrate. Further, in the array substrate, the scanning wiring lines 32 and the data wiring lines 33 forming a lattice pattern are so disposed as to surround the pixel electrodes 30 and the memory circuits 50 on the circumference thereof. With this configuration, when the memory pixel section 20 continues to display the same image, the pixel electrode 30 is supplied with a potential from the display voltage supply circuit 52. That is, since the memory pixel section 20 need not carry out a data write operation such as that carried out in the non-memory pixel section 21, power consumption may be substantially eliminated when the same image is continued to be displayed. Note that, color filters are not disposed in the memory pixel region A2 in the counter substrate. In other words, in the present example, monotone image display can be made in the memory pixel region A2.

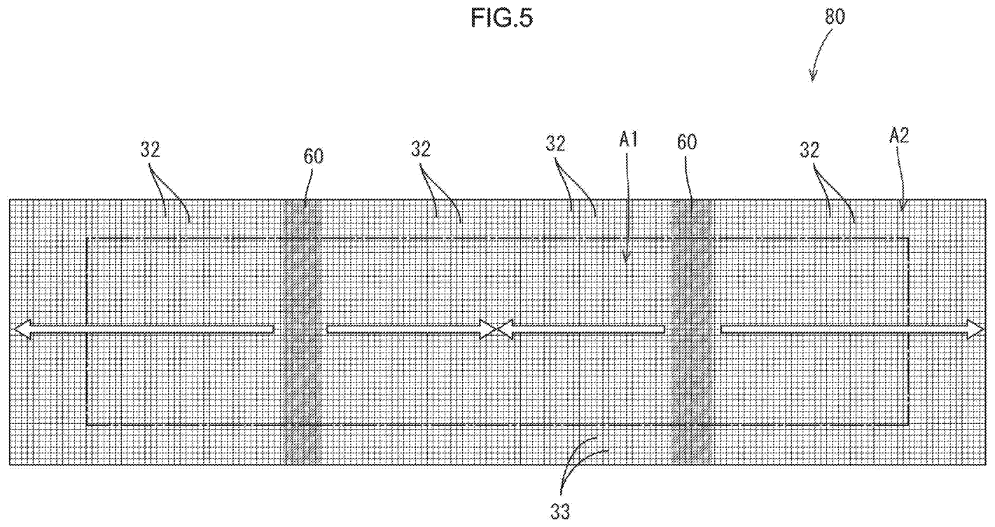

Note that the liquid crystal panel 10 is formed by cutting a liquid crystal panel before cutting 80 having a rectangular shape, as illustrated in FIG. 5. The liquid crystal panel before cutting 80 includes a gate driver circuit portion 60, which is a drive circuit to supply a scanning signal to the scanning wiring line 32. The liquid crystal panel 10 is referred to as a so-called Free Form Display (FFD: trade name), and as illustrated in FIG. 5, the gate driver circuit portion 60 is disposed in the display region, specifically, is disposed overlapping the memory pixel region A2 and the non-memory pixel region A1.

To be specific, the gate driver circuit portion 60 is formed monolithically on the array substrate while including, as a base, the same semiconductor film (oxide semiconductor material) as that of the TFT 31, thereby having a control circuit to control the supply of an output signal (scanning signal) to the TFT 31. The control circuit includes a circuit configured to output the scanning signal at a predetermined timing, a buffer circuit to amplify the scanning signal, and the like. Circuit elements included in the above control circuit include, for example, a circuitry TFT using a semiconductor film as a channel portion (a circuitry switching element), and the like. Further, the control circuit includes a circuitry wiring-line portion (not illustrated) using the same metal film as the scanning wiring line 32 and the data wiring line 33, or the like. The gate driver circuit portions 60 are each provided by dispersedly disposing control circuits (a circuitry TFT, a circuitry wiring-line portion, and the like) in the pixel sections 20 and 21 present in each of a plurality of belt-shaped regions separated from each other in the X-axis direction. The gate driver circuit portions 60 extend along the Y-axis direction and are disposed at two locations separated from each other in the X-axis direction. Note that, in FIG. 5, a shaded and longitudinally long belt-shaped region represents a formation range of the gate driver circuit portion 60. With the above configuration, the scanning wiring line 32 is formed to extend toward both sides in the X-axis direction from each of the two gate driver circuit portions 60, and the scanning signal is supplied toward arrow directions illustrated in FIG. 5.

Since the liquid crystal panel before cutting 80 is configured as described above, it is possible to cut the outer circumference portion. Then, the liquid crystal panel 10 is formed by cutting out parts of the memory pixel region A2 on both end sides in the X-axis direction of the liquid crystal panel before cutting 80. In other words, the manufacturing method for the room mirror monitor 11 as the display device includes a cutting process of forming a shape fitted for the frame-shaped frame member 13 by cutting out parts of the memory pixel region A2 of the liquid crystal panel 10. Note that the liquid crystal panel 10 may also be reused by cutting out parts of the memory pixel region A2 to be fitted for another frame. Incidentally, in the present example, the memory pixel region A2 is described to be larger in size than the actual one in order to facilitate the understanding of features of the present invention. In addition, a data driver for supplying data signals to the data wiring line may be configured in such a manner that, for example, after the liquid crystal panel before cutting 80 is cut, a flexible substrate is connected to the liquid crystal panel 10, and then the data driver is mounted on the flexible substrate by a chip on film (COF) method.

As described above, the liquid crystal panel 10 includes the memory pixel section 20 having the memory circuit 50 configured to store display data, and the non-memory pixel section 21 not having a function of storing display data, wherein the plurality of memory pixel sections 20 are disposed on the outer circumference side of the plurality of non-memory pixel sections 21. With such a configuration, while displaying an image in the non-memory pixel section 21, the liquid crystal panel 10 is able to perform display for a frame region on the periphery of the image in the memory pixel section 20. In a region between the frame member 13 and the non-memory pixel region A1 where the non-memory pixel section 21 is disposed, an image can be displayed by the memory pixel section 20. Furthermore, since the memory pixel section 20 is used when performing display for the frame region, power consumption in performing the display for the frame region may be substantially eliminated. Thus, according to the liquid crystal panel 10, it is possible to achieve the display device (room mirror monitor 11) excellent in designability while suppressing the power consumption.

Moreover, the liquid crystal panel 10 is configured such that the plurality of memory pixel sections 20 are disposed to surround the entire circumference of the non-memory pixel region A1 formed by the plurality of non-memory pixel sections 21. Accordingly, since the frame display using the memory pixel sections 20 can be performed across the entire circumference, it is possible to further enhance the designability of the display device (room mirror monitor) while suppressing the power consumption. In addition, the liquid crystal panel 80 can be easily formed in a shape fitted for frames of various shapes, thereby having a high flexibility in formation.

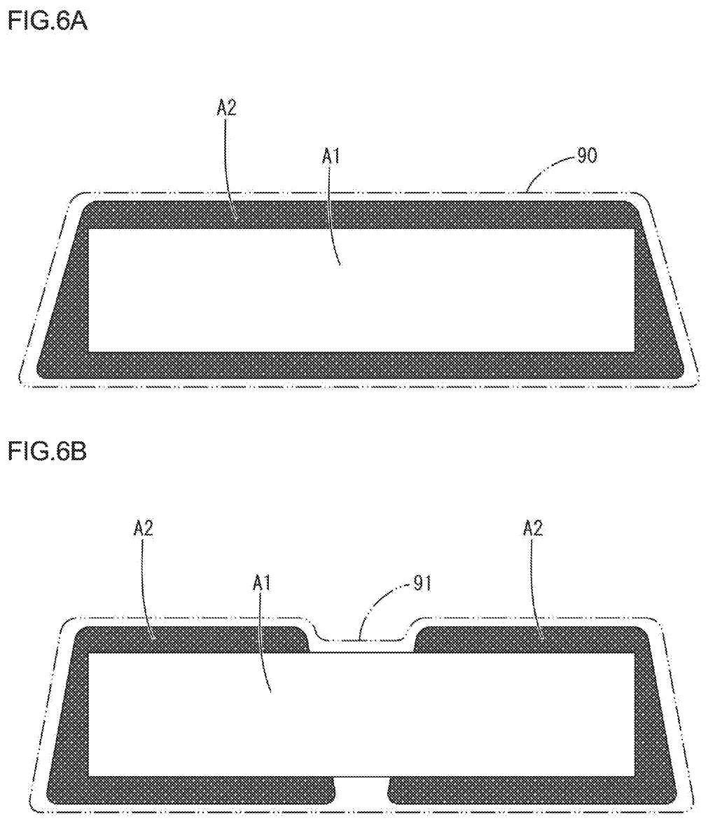

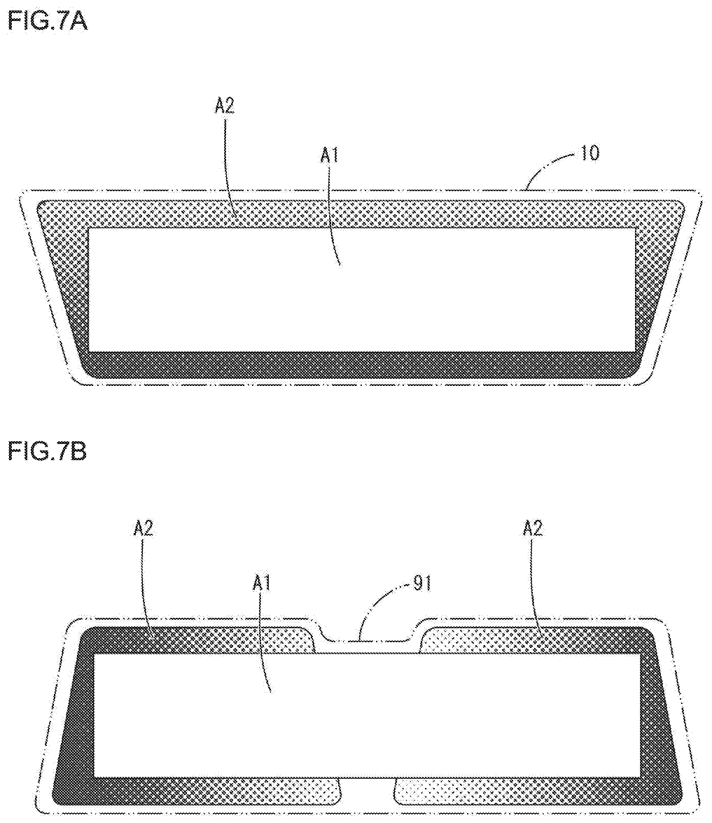

Further, because the liquid crystal panel 10 and the liquid crystal panel before cutting 80 are FFDs, these panels are configured to be able to be cut in the memory pixel region A2, and able to be formed in a shape fitted for frames of various shapes while securing the non-memory pixel region A1, which is a display region in the non-memory pixel sections 21. For example, it is also possible to cut the liquid crystal panel before cutting 80 into a liquid crystal panel 90 fitted for a trapezoidal frame as illustrated in FIG. 6A, or a liquid crystal panel 91 fitted for a frame of a shape, part of which projects toward an inner side of the display surface as illustrated in FIG. 6B. Further, as illustrated in FIG. 7A and FIG. 7B, it is also possible to apply gradation with monotone or apply various images with monotone in the memory pixel region A2.

Furthermore, when the room mirror monitor 11 using the liquid crystal panel 10 is set to a mirror state, since the liquid crystal panel 10 is not provided with a black matrix between the non-memory pixel region A1 and the frame member 13, but is provided with the memory pixel region A2 instead, it is possible to use, as a mirror, the entire inner-side surface of the frame member 13 in the liquid crystal panel 10.

### Example 2

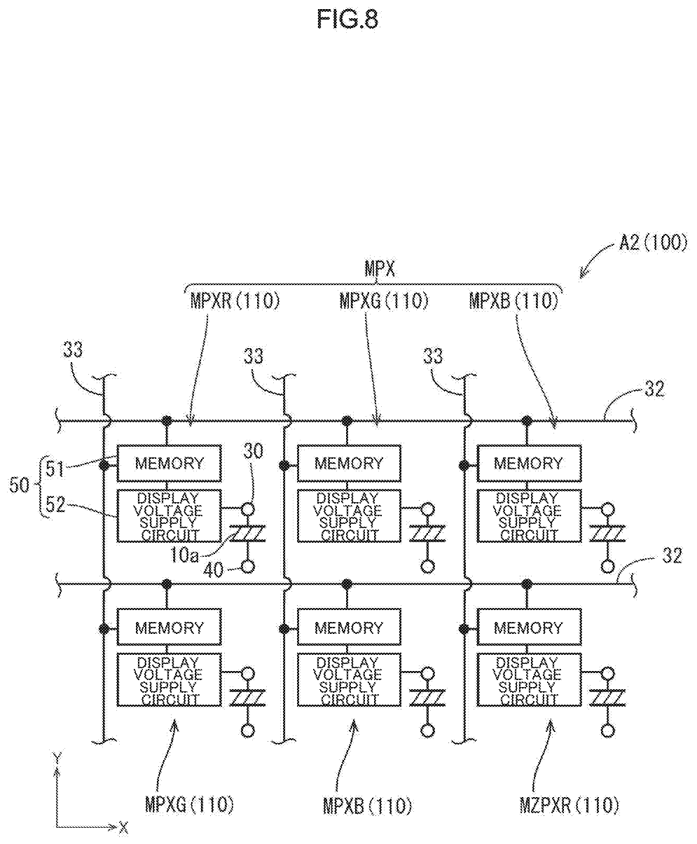

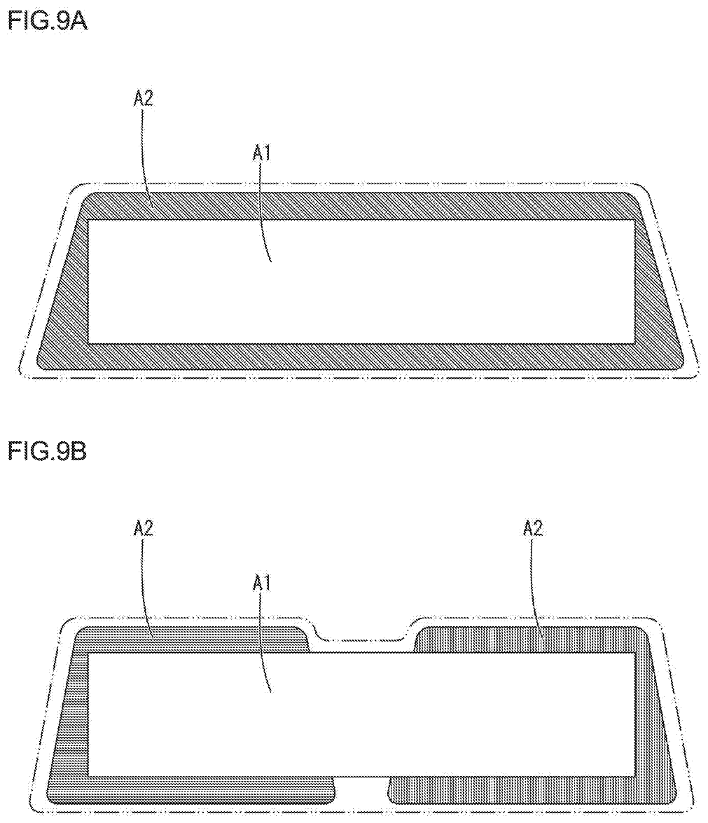

Next, a liquid crystal panel 100, which is a display panel of a second example, will be described with reference to FIG. 8 and FIG. 9. Similar to the liquid crystal panel 10 of the first example, the liquid crystal panel 100 of the second example is used in a room mirror monitor, and has a substantially similar configuration to that of the first example. However, the structure in a memory pixel region A2 of the liquid crystal panel 100, to be specific, only the configuration of a memory pixel section 110 thereof differs from the configuration of the memory pixel section 20 of the first example.

Specifically, the structure of a counter substrate in the memory pixel region A2 is different from that of the counter substrate in the first example. In the counter substrate of the liquid crystal panel 100, multiple color filters are provided being arranged in a matrix shape at positions facing each of the pixel electrodes 30 on an array substrate side. Similar to the non-memory pixel region A1 of the first example, filters configured to exhibit three colors of red, green, and blue (R, G, B) are repeatedly disposed being arranged in a predetermined order. Then, in the liquid crystal panel 100, not only in a non-memory pixel region A1 but also in the memory pixel region A2, a memory display pixel MPX, which is a display pixel having a memory function and serving as a display unit, is constituted by color filters of red, green and blue of three colors, and three sets of pixel electrodes 30 and memory circuits 50 facing the color filters. In other words, the memory display pixel MPX is constituted by three memory pixel sections 110. To be specific, the memory display pixel MPX includes a red memory pixel section MPXR constituted of a color filter configured to exhibit red color and the pixel electrode 30 and memory circuit 50 facing the red color filter, a green memory pixel section MPXG constituted of a color filter configured to exhibit green color and the pixel electrode 30 and memory circuit 50 facing the green color filter, and a blue memory pixel section MPXB constituted of a color filter configured to exhibit blue color and the pixel electrode 30 and memory circuit 50 facing the blue color filter.

With such a configuration, the liquid crystal panel 100 includes, similarly to the liquid crystal panel 110 of the first example, a memory pixel section 110 having the memory circuit 50 configured to store display data, and a non-memory pixel section 21 not having a function of storing display data, wherein a plurality of memory pixel sections 110 are disposed on the outer circumference side of a plurality of non-memory pixel sections 21. Accordingly, the liquid crystal panel 100 also makes it possible to achieve a display device excellent in designability while suppressing the power consumption.

In addition to the above, in the liquid crystal panel 100 of the second example, color display can be performed in the memory pixel region A2. Because of this, in a case where the frame is green, for example, the presence of the frame region of the liquid crystal panel 100 may be made less noticeable by performing green monochrome display in the memory pixel region A2, as illustrated in FIG. 9A. Alternatively, for example, as illustrated in FIG. 9B, it is possible to cause the region of the right half to be red, cause the region of the left half to be blue, and display various images matching the color, design, and the like of the frame. Thus, in the liquid crystal panel 100 of the second example, the display panel of this configuration may further enhance the designability of the display device.

### Other Embodiments

In the liquid crystal panels 10 and 100 of the two examples described above, although the memory pixel sections are disposed across the entire circumference of the non-memory pixel sections, it is sufficient that the memory pixel sections are disposed on at least part of the outer circumference, for example, disposed only on both sides thereof, or the like, in the left and right direction. Note that a black matrix may be disposed in a portion where the memory pixel section is not disposed. Further, the memory pixel section is not limited to a memory-in-pixel scheme, and electronic paper, ferroelectric liquid crystal, or the like may be adopted. However, in consideration of power consumption, image rewriting time, visibility, and the like, the memory-in-pixel scheme is desirable. In addition, the display panel of the present invention is not limited to a liquid crystal panel, and may also be adopted in an organic EL panel or the like. Furthermore, the display panel of the present invention is not limited to a room mirror monitor; the display panel of the present invention may be adopted in various types of products such as a wearable terminal, or the like, and is particularly effective for a product required to be excellent in designability.

Note that in the case where an organic EL panel is employed as the display panel of the present invention, the configuration in which memory pixels can be displayed in color is not limited to a color filter scheme; alternatively, a scheme of using light-emitting layers of red, green and blue, or a scheme of achieving red and green colors by using a blue-light-emitting layer and then by passing part of the light emitted therefrom through a color conversion layer may be employed.

The gate driver circuit portion 60, which is a drive circuit, is disposed to extend in a direction orthogonal to the scanning wiring line 32 in such a manner as to cross the memory pixel region A2 and the non-memory pixel region A1, but a plurality of drive circuits may be disposed being arranged in a dispersed manner in the above direction. Such a configuration may bring a display panel with a higher flexibility in formation.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A display panel comprising:
a memory pixel section including a memory circuit configured to store display data; and
a non-memory pixel section that does not have a function of storing display data,
wherein a plurality of the memory pixel sections are disposed on an outer circumference side of a plurality of the non-memory pixel sections.

2. The display panel according to claim 1,
wherein the plurality of memory pixel sections are disposed to surround an entire circumference of a non-memory pixel region formed by the plurality of non-memory pixel sections.

3. The display panel according to claim 1,
wherein color display is able to be performed in a memory pixel region formed by the plurality of memory pixel sections.

4. The display panel according to claim 1,
wherein the display panel is configured to be able to switch between a display state to display an image and a mirror state to function as a mirror.

5. The display panel according to claim 1,
wherein the display panel further includes a drive circuit designed to supply scanning signals to the plurality of memory pixel sections and to the plurality of non-memory pixel sections, and scanning wiring lines configured to supply the scanning signals to the memory pixel sections and to the non-memory pixel sections,
the drive circuit is disposed overlapping a memory pixel region formed by the plurality of memory pixel sections and a non-memory pixel region formed by the plurality of non-memory pixel sections, and
the scanning wiring lines are disposed to extend toward both sides from the drive circuit.

6. A manufacturing method for a display device configured to include the display panel according to claim 5 and a frame member that is formed in a frame shape and holds the display panel, the method comprising:
cutting out part of the memory pixel region of the display panel to form a shape fitted for the frame member.
